(19) United States
(12) Patent Application Publication
(10) Pub. No.: US 2007/0130608 A1
(43) Pub. Date: Jun. 7, 2007

(54) Method and apparatus for overlaying broadcast video with application graphic in DTV

(75) Inventors: Hee-chul Han, Seoul (KR); Se-huhn Hur, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/595,932

(22) Filed: Nov. 13, 2006

(30) Foreign Application Priority Data
Dec. 5, 2005 (KR) 10-2005-0117668

(51) Int. Cl. H04N 7/16; H04N 7/173

(52) U.S. Cl. 725/132; 725/140; 725/152

(57) ABSTRACT

A method and apparatus for overlaying broadcast video with application graphics in a digital TV having an application-execution function are provided. The apparatus includes a decoding unit which decodes a received digital broadcast signal and outputs a video signal, a memory unit which stores graphic data used for the application, and an embedded central processing unit (CPU) comprising a video processor which overlays the video signal directly received through a dedicated input port from the decoding unit with the graphic data stored in the memory unit, so that the overlaid result makes one screen.

### CROSS-REFERENCE TO RELATED PATENT APPLICATIONS

This application claims priority from Korean Patent Application No. 10-2005-0117668, filed on Dec. 5, 2005, in the Korean Intellectual Property Office, the disclosure of which is incorporated herein in its entirety by reference.

### BACKGROUND OF THE INVENTION

1. Field of the Invention

Methods and apparatuses consistent with the present invention relate to a digital TV, and more particularly, to overlaying broadcast video with application graphics in a digital TV having an application-execution function.

2. Description of the Related Art

As the convergence trend of digital consumer electronic appliances has been accelerated, a digital TV with which digital broadcasting can be watched has begun to process applications, such as games and Internet browsers, in order to provide a variety of services to users in addition to reception of broadcasting. Accordingly, the digital TV now requires a high-end central processing unit (CPU) capable of processing more data. Since the capability of an advanced reduced instruction set computer (RISC) machine (ARM) or million instructions per second (MIPS) CPU that is a related embedded CPU is not sufficient for use in a digital TV requiring a CPU with a 500 MHz or higher speed, a digital TV employing an x86 processor that is a general-purpose CPU instead of the related CPUs has been introduced.

FIG. 1 illustrates a process of outputting a screen through a video processor of an x86 chip in a related digital TV based on the x86 chip.

As illustrated in FIG. 1, an x86 system can be split into two parts centered around a north bridge 110 and a south bridge 120, respectively. The north bridge 110 connects a CPU 100, a memory 130, and a peripheral component interconnect (PCI) bus, and provides a high data rate. The south bridge 120 manages relatively slow data lines connecting peripheral devices, such as a hard disc data line, a universal serial bus (USB) bus, and an industry standard architecture (ISA) bus, and can be connected to the CPU 100 through the north bridge 110. An MPEG decoder 150 decodes digital broadcast data received from the outside in an MPEG transport stream format and outputs a video signal. In the following exemplary embodiments of the present invention, it is assumed that broadcast data is compressed according to the MPEG standard, but the compression format is not limited to the MPEG.

In a related method of processing a signal in a digital TV based on the system described above, the x86 CPU 100 generates graphics related to a variety of applications, such as games and web browsers, and stores the graphics in the main memory 130. Meanwhile, the MPEG decoder 150 decodes a transport stream received from the outside, generates a video signal, and transmits the generated video signal to the main memory 130 through the north bridge 110 using the PCI bus. A video processor 140 included in the x86 architecture overlays the application graphics of the memory 130 with broadcast video, processes the graphics and video to form a screen, and outputs the screen through a display apparatus. At this time, in order for a user to watch the digital broadcasting, a huge amount of broadcast video data should be transmitted in real time and the bandwidth of the PCI bus should be occupied exclusively such that it is difficult to perform other jobs at the same time.

FIG. 2 illustrates a process of outputting a screen through an MPEG decoder in a conventional digital TV based on an x86 chip.

According to the example of FIG. 2, unlike the example of FIG. 1, broadcast video data is not transmitted to a video processor 240, and application graphic data stored in a memory 230 is transmitted to an MPEG decoder 250. In the MPEG decoder 250, the application graphics and the broadcast video are overlaid and processed and then output to a screen.

Since the size of graphic data related to execution of an application is relatively much smaller than that of broadcast video data, if the MPEG decoder is made to overlay and process the application graphics with broadcast video as illustrated in FIG. 2, the exclusive occupation problem of the PCI bus as shown in FIG. 1 becomes lessened. However, since the graphic processing performance of an MPEG decoder is generally much lower than that of a video process in an x86 architecture, if the method of FIG. 2 is employed, the overlaying and processing of the screen become dependent on the graphic processing performance of the MPEG decoder such that the quality of picture is degraded.

FIG. 3 illustrates a method of overlaying application graphics with broadcast video by using a video interface port (VIP) in a related embedded x86 system. Many of the elements shown in FIG. 3 are well known in the art, and description thereof is excluded.

The VIP is a dynamic memory allocation (DMA) engine and a port which is used to transmit a video signal complying with a video electronics standards association (VESA) 2.0 standard. That is, if the VIP is employed, an embedded x86 CPU and an MPEG decoder are directly connected without passing through a PCI bus, the problem of FIG. 1 is addressed. Also, since a graphic processing function of an x86 architecture can be used for outputting a screen, the problem of FIG. 2 can be addressed.

However, when elements requiring a memory share one main memory in a digital TV mounting an embedded CPU, an overload can occur in a process of accessing the memory to output a screen. Both application graphic data and broadcast video data that form one screen are stored in the main memory, and then, overlaid in a video processor. However, since only one memory address can be accessed at one clock cycle, the system clock speed should be raised in order to output one screen in real time.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

An aspect of the present invention provides a method and apparatus for overlaying application graphics with broadcast video in a digital TV.

According to an aspect of the present invention, there is provided a digital TV apparatus having an application-execution function, the apparatus including: a decoding unit that decodes a received digital broadcast signal and outputs a video signal; a memory unit that stores graphic data used for the application; and an embedded central processing unit (CPU) that overlays the video signal directly received through a dedicated port from the decoding unit, with the graphic data stored in the memory unit, by using the CPU's own video processor, so that the overlaid result makes one screen.

The dedicated input port may be a Video Interface Port (VIP), and the CPU may be an embedded x86 processor.

According to another aspect of the present invention, there is provided a method of processing a signal in a digital TV having an application-execution function, the method including: storing graphic data used for the application in a memory; transmitting a video signal generated by decoding digital broadcast data to an embedded CPU through a dedicated port; and overlaying the transmitted video signal with the graphic data stored in the memory using the CPU's own video processor, so that the overlaid result makes one screen.

The dedicated input port may be a Video Interface Port (VIP) and the CPU may be an embedded x86 processor.

According to another aspect of the present invention, there is provided a computer readable recoding medium having embodied thereon a computer program for executing the method.

According to another aspect of the present invention, there is provided an embedded CPU apparatus mounted on a digital TV apparatus having an application-execution function, the embedded CPU apparatus including: a memory controller that extracts graphic data used for the application from an external memory; an input port that receives a video signal generated by decoding a digital broadcast signal, through a dedicated interface; and a video processor that overlays the graphic data extracted by the memory controller and the video signal received through the input port and outputs the result signal which makes one screen.

According to another aspect of the present invention, there is provided a method of processing a signal in an embedded CPU mounted on a digital TV apparatus having an application-execution function, the method including: extracting graphic data used for the application from an external memory; receiving a video signal generated by decoding a digital broadcast signal through a dedicated interface; and overlaying the video signal received through the input port with the graphic data extracted by the memory controller using the embedded CPU's own video processor, and outputting the result signal which makes one screen.

According to still another aspect of the present invention, there is provided a computer readable recording medium having embodied thereon a computer program for executing the method of processing a signal in a digital TV having an application-execution function.

### BRIEF DESCRIPTION OF THE DRAWINGS

The above and other aspects of the present invention will become more apparent by describing in detail exemplary embodiments thereof with reference to the attached drawings in which:

FIG. 1 illustrates a process of outputting a screen through a video processor of an x86 chip in a related art digital TV based on the x86 chip;

FIG. 2 illustrates a process of outputting a screen through an MPEG decoder in a related art digital TV based on an x86 chip;

FIG. 3 illustrates a method of overlaying application graphics with broadcast video by using a video interface port (VIP) in a related art embedded x86 system;

FIG. 4 is a block diagram of a structure of an embedded x86 processor overlaying application graphics with broadcast video according to an exemplary embodiment of the present invention; and

FIG. 5 is a flowchart illustrating a method of overlaying application graphics with broadcast video according to an exemplary embodiment of the present invention.

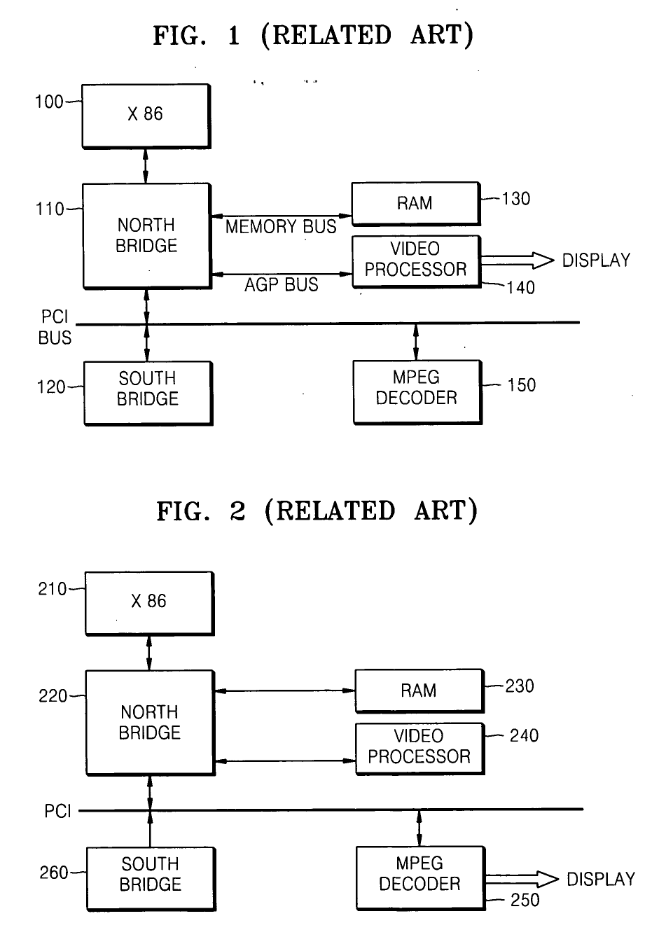

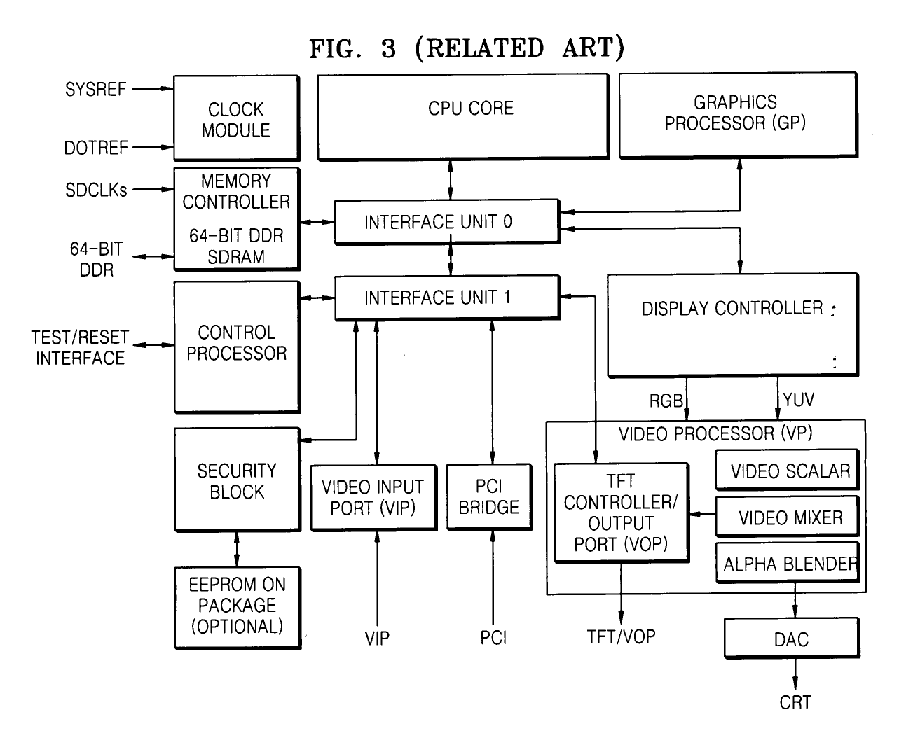

### DETAILED DESCRIPTION OF THE EXEMPLARY EMBODIMENTS OF THE INVENTION

The present invention will now be described more fully with reference to the accompanying drawings, in which exemplary embodiments of the invention are shown.

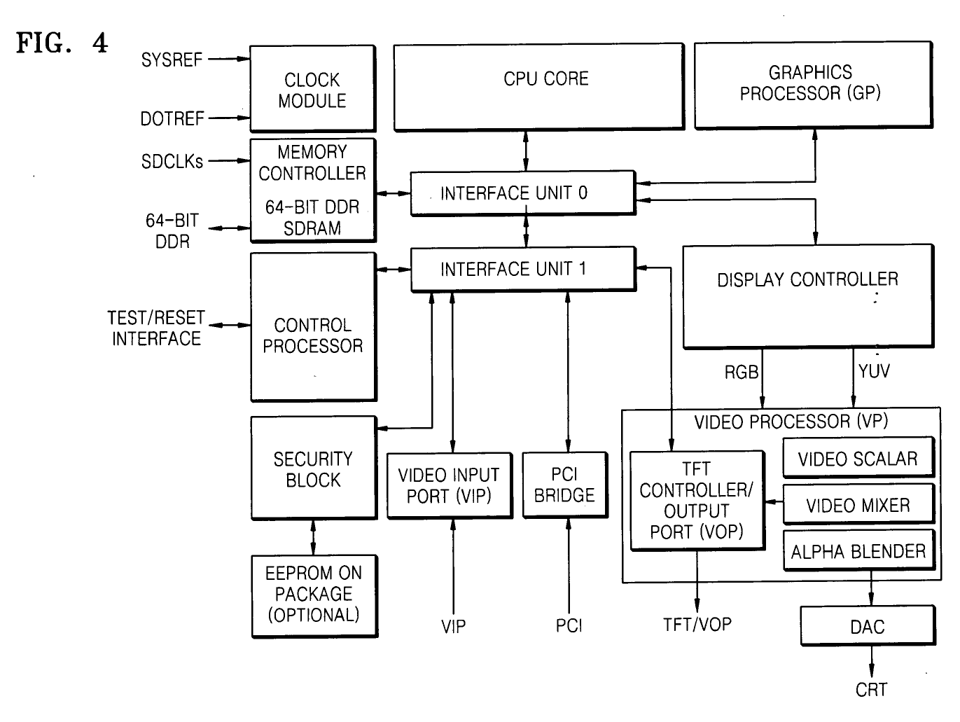

FIG. 4 is a block diagram of a structure of an embedded x86 processor overlaying application graphics with broadcast video according to an exemplary embodiment of the present invention. Many of the elements shown in FIG. 4 are well known in the art, and description thereof is excluded.

As illustrated in FIG. 4, the embedded x86 CPU includes a video input port (VIP) for receiving a broadcast signal from a DTV module (not shown), an interface unit 0 connecting high-speed modules, an interface unit 1 connecting low-speed modules, a graphics processor that generates graphics related to a variety of applications, a memory that stores a broadcast signal and a graphic signal, a display controller fetching data to be displayed on a display apparatus from the memory, and a video processor that processes a broadcast signal and graphics related to applications and outputs processed data to the display apparatus.

In the embedded x86 CPU, according to an exemplary embodiment of the present invention, a broadcast video signal output is received from an MPEG decoder (not shown) through a VIP not though a PCI bus. The video signal received through the VIP is input to the video processor through the interface unit 1. Meanwhile, graphic data generated by the graphic processor is stored in a main memory outside the CPU and then, is input to the video processor through a memory controller, the interface unit 0, and the display controller. The video processor receiving the inputs of the video signal and the graphic data overlays the graphic with the video, and at the same time performs a processing process, such as scaling and alpha blending, and outputs the result to a screen.

That is, according to the present exemplary embodiment, the video signal output from the MPEG decoder and input through the VIP is directly input to the video processor and overlaid with the application graphics. Accordingly, since only the application graphic data is stored in the main memory and the video signal to be overlaid with the application graphics is not stored in the main memory, the number of times that the memory is accessed in order to output a screen can be reduced compared to that of the related art technology. Meanwhile, the interface between the MPEG decoder and the embedded x86 CPU is not limited to the VIP and can be replaced by another signal line that does not use the PCI bus.

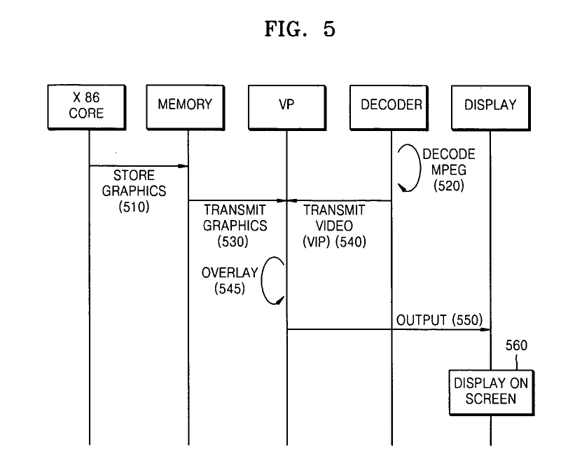

FIG. 5 is a flowchart illustrating a method of overlaying application graphics with broadcast video according to an exemplary embodiment of the present invention.

An x86 core generates graphics related to applications by using a graphic processor and stores the graphics in a memory in operation 510. Meanwhile, an MPEG decoder decodes a received MPEG transport stream and outputs a broadcast video signal in operation 520. A video processor receives the application graphic data through a memory controller, interface unit 0, and a display controller in operation 530.

From the MPEG decoder, the video processor receives the broadcast video signal through a VIP in operation 540. Then, in operation 545, the graphics are overlayed with the video signal, and the video processor outputs the result on a screen in operation 550. A display apparatus, such as a CRT and an LCD, displays the signal output from the video processor to a user in operation 560.

The present invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet).

While the present invention has been particularly shown and described with reference to exemplary embodiments thereof, it will be understood by those of ordinary skill in the art that various changes in form and details may be made therein without departing from the spirit and scope of the present invention as defined by the following claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

According to the present invention as described above, the number of times that a memory is accessed in order to display application graphics and a video signal at the same time can be reduced. In addition, since the bandwidth of a PCI bus does not need to be monopolized for transmission of a video signal, the system bus can be managed efficiently.

What is claimed is:

1. A digital TV apparatus having an application-execution function, the apparatus comprising:
a decoding unit which decodes a received digital broadcast signal and outputs a video signal;
a memory unit which stores graphic data used for the application; and
an embedded central processing unit (CPU) comprising a video processor which overlays the video signal directly received through a dedicated input port from the decoding unit with the graphic data stored in the memory unit, so that the overlaid result makes one screen.

2. The apparatus of claim 1, wherein the dedicated input port is a Video Interface Port (VIP).

3. The apparatus of claim 1, wherein the CPU is an embedded x86 processor.

4. A method of processing a signal in a digital TV having an application-execution function, the method comprising:
storing graphic data used for the application in a memory;
transmitting a video signal generated by decoding digital broadcast data, to an embedded CPU through a dedicated input port; and
overlaying the transmitted video signal with the graphic data stored in the memory, so that the overlaid result makes one screen.

5. The method of claim 4, wherein the dedicated input port is a Video Interface Port (VIP).

6. The method of claim 4, overlaying is performed by a video processor located within the embedded CPU.

7. The method of claim 4, wherein the CPU is an embedded x86 processor.

8. A computer readable recoding medium having embodied thereon a computer program for executing the method of claim 4.

9. An embedded CPU apparatus mounted on a digital TV apparatus having an application-execution function, the embedded CPU apparatus comprising:
a memory controller which extracts graphic data used for the application from an external memory;
an input port which receives a video signal generated by decoding a digital broadcast signal through a dedicated interface; and
a video processor which overlays the graphic data extracted by the memory controller and the video signal received through the input port and outputs the result signal resulting in a single screen.

10. The apparatus of claim 9, wherein the dedicated input port is Video Interface Port (VIP).

11. A method of processing a signal in an embedded CPU mounted on a digital TV apparatus having an application-execution function, the method comprising:
extracting graphic data used for the application from an external memory;
receiving a video signal. generated by decoding a digital broadcast signal, through a dedicated interface; and
overlaying the video signal received through the input port with the graphic data extracted by the memory controller using a video processor located within the embedded CPU, and
outputting the result signal which results in a single screen.

12. The method of claim 11, wherein the dedicated input port is a Video Interface Port (VIP).

13. A computer readable recoding medium having embodied thereon a computer program for executing the method of claim 11.
